(19) United States
(12) Patent Application Publication
(10) Pub. No.: US 2021/0155512 A1
(43) Pub. Date: May 27, 2021

(54) RECYCLING OF WATER IN A MINING BY-PRODUCT

(71) Applicants: Mehdi BOUZID, Sainte foy les lyon (FR); COATEX, Genay (FR)

(72) Inventor: Mehdi BOUZID, Sainte Foy les Lyon (FR)

(73) Assignee: COATEX, Genay (FR)

(21) Appl. No.: 16/972,260

(22) PCT Filed: Jun. 5, 2019
(86) PCT No.: PCT/FR2019/000091

§ 371 Date: Dec. 4, 2020

(30) Foreign Application Priority Data
Jun. 8, 2018 (FR) 18 54990

(51) Int. Cl. C02F 1/56; B01D 21/01; C02F 1/72

(52) U.S. Cl. CPC C02F 1/56; C02F 2103/10; C02F 1/722; B01D 21/01

(57) ABSTRACT

The invention relates to a method for preparing an aqueous suspension (S) of mineral particles of a metal ore, of a metal ore residue or of a metal to be recycled comprising a particular polymer (P) and recycle water originating from an aqueous metal ore residue, an aqueous metal ore suspension or an aqueous suspension of a metal to be recycled. The invention also relates to a method for controlling, improving or reducing the turbidity of the supernatant water originating from an aqueous suspension (S). The invention also provides an aqueous suspension (S).

The invention relates to a method for preparing an aqueous suspension (S) of mineral particles of a mineral ore, of a metal ore residue or of a useable metal comprising a particular polymer (P) and recycling water from an aqueous metal ore residue, from an aqueous suspension of metal ore or from an aqueous suspension of a useable metal. The invention also relates to a method for controlling, improving or reducing the turbidity of the supernatant water from an aqueous suspension (S). The invention also provides an aqueous suspension (S).

The method according to the invention is used in a mining process involving at least one mineral deposit. These mining methods generally make it possible to obtain at least one useable metal from a metal ore. The metal ore also comprises a residue of this metal ore. The mining methods are usually implemented using water as a medium for processing or conveying the dry solids content. These mining methods can be used for various mining derivatives that can be a metal ore, a useable metal, a derivative of a useable metal or a metal ore residue.

According to the invention, the aqueous metal ore residue thus results from at least one step in which the useable metal or a derivative of the useable metal is separated from a metal ore, in particular a metal ore produced by mining extraction. According to the invention, the fraction of the useable metal ore is a metal or several metals or a derivative of a metal or a derivative of several metals.

When using the method of preparation according to the invention, an essential step consists of adding at least one polymer (P) to particles of a mining derivative. This step is therefore generally used in a mining method comprising various steps for processing the metal ore and various steps for processing the metal ore residue and the useable metal or the derivative of the useable metal.

Typically, mining methods comprise several steps for processing the metal ore, several steps for processing the useable metal or for processing the derivative of the useable metal, as well as several steps for processing the metal ore residue.

A mining method typically comprises one or more of the following steps:
crushing the metal ore,
grinding the metal ore, in particular dry grinding or wet grinding, usually in water,
separating, in particular by flotation, the useable metal or a derivative of the useable metal and the metal ore residue, particularly the aqueous residue,
purifying or enriching the useable metal or a derivative of the useable metal, in particular by flotation,
concentrating the metal ore residue or the useable metal or a derivative of the useable metal, for example by filtration, by settling, by gravity, by using a thickener, by flocculation,
partially separating the aqueous metal ore residue and part of the water,
conveying the metal ore, the aqueous metal ore residue or the useable metal or a derivative of the useable metal,
storing the metal ore, the aqueous metal ore residue or the useable metal or a derivative of the useable metal.

As the case may be, it is important to have effective methods that do not result in a decrease in the settling speed.

There are known methods for preparing an aqueous mineral suspension from a mining derivative, particularly the methods used to process, convey or store such a derivative. Suspensions of mining derivatives can have particles of dry solids content with a particle size distribution that is relatively coarse or is not very uniform.

Document EP 636578 describes the fluidification of flocculated suspensions of red mud in the manufacture of bauxite by the Bayer method, using a flocculating agent and a dispersing agent (D).

Document GB 1414964 relates to a method for deflocculating a particulate material that consists of adding a copolymer or a water-soluble derivative of a vinyl copolymer to a grout of the particulate material.

Document WO 2007-082797 describes a method for concentrating an aqueous suspension of solid particles combining the use of a flocculant polymer and the use of radiation or of radical agents, oxidising agents or enzymes.

Document WO 2017-097799 discloses a method for processing an aqueous effluent resulting from oil sands mining operations that comprises the addition of a sulphonated dispersing agent and then the addition of a flocculating agent.

To facilitate their handling, the known suspensions typically have a lower solids content. In fact, adding water may help to lower the viscosity or the flow threshold of these suspensions.

However, adding water leads to problems with water and energy consumption.

Compatibility with the various constituents of aqueous mineral suspensions prepared from a mining derivative is also an important property to look for, in particular compatibility with a flocculating agent that can be used to process the aqueous metal ore residue, in particular compatibility with a polyacrylamide or a polyacrylamide derivative.

Likewise, it is important to be able to control the viscosity of aqueous mineral suspensions prepared from a mining derivative, in particular to make it easier to pump, stir or convey them.

Moreover, it is important to have methods that make it possible to control the flow threshold of the prepared suspensions. It is particularly important to confer on a suspension a flow threshold with a minimum threshold value that makes it possible to eliminate or reduce the risk of the solid portion of the residue settling in case there is no shearing or if there is slight shearing.

Most importantly, reducing the consumption of water when processing mining derivatives should also be sought. Water recovery or recycling during the various steps in the mining methods is therefore essential. Both the amount of water that is separated or recycled and the quality of the separated or recycled water, particularly its limited turbidity, should be sought.

When implementing a mining method, the recycling water is separated water, in particular separated supernatant water. Recycling water can come from a step in a mining process that uses a thickener of a material to be concentrated or from a storage pond, such as a pond used for storing an aqueous metal ore residue or for storing a mud of metal ore residue.

It is also important to be able to control the behaviour of the aqueous mineral suspensions prepared from a mining derivative in order to avoid problems with the processing, storing or conveying equipment. Indeed, this equipment can be damaged, jammed or clogged if there is a drift in or lack of control of the viscosity or the flow threshold of an aqueous mineral suspension prepared from a mining derivative.

There is a therefore a need for improved methods for preparing an aqueous mineral suspension from a mining derivative, particularly for the preparation of aqueous suspensions of mineral particles of a metal ore, of a metal ore residue or of a useable metal or of a derivative of a useable metal.

This need is even greater if the water used is recycling water. In particular, there is an even greater need to have such methods that use recycling water from at least one step in a mining process.

The method according to the invention provides a solution to all or part of the problems with the methods used in the prior art to prepare an aqueous mineral suspension from mining derivatives.

Thus, the invention provides a method for preparing an aqueous mineral suspension (S) of mineral particles chosen among particles of at least one metal ore, particles of at least one metal ore residue, particles of at least one useable metal or of at least one derivative of a useable metal, and combinations thereof, comprising the addition in a mixture (ME) chosen among:
a mixture (ME1) comprising water and particles of at least one metal ore,
a mixture (ME2) comprising water and particles of at least one metal ore residue,
a mixture (ME3) comprising water and particles of at least one useable metal or of at least one derivative of a useable metal,
a mixture (ME4) comprising at least two mixtures chosen among (ME1), (ME2) and (ME3),
   recycling water from at least one aqueous metal ore residue or from at least one aqueous suspension of metal ore or from at least one aqueous suspension of a useable metal or of a derivative of a useable metal and
   comprising at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound chosen among hydrogen peroxide, benzoyl peroxide, acetyl peroxide, lauryl peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof.

The method according to the invention makes it possible to prepare an aqueous suspension (S) of mineral particles from various mining derivatives. According to the invention, the mining derivative is chosen among a metal ore, a metal ore residue, a useable metal and a derivative of a useable metal.

The mixture (ME) according to the invention is chosen among mixtures (ME1), (ME2), (ME3) and (ME4).

According to the invention, mixture (ME1) is prepared by mixing water and particles of at least one metal ore.

According to the invention, mixture (ME2) is prepared by mixing water and particles of at least one metal ore residue.

According to the invention, mixture (ME3) is prepared by mixing water and particles of at least one useable metal or by mixing water and particles of at least one derivative of a useable metal.

According to the invention, mixture (ME4) is prepared by mixing at least two mixtures chosen among (ME1), (ME2) and (ME3). Mixture (ME4) can also be prepared by mixing water and particles of at least one metal ore or by mixing water and particles of at least one metal ore residue or by mixing water and particles of at least one useable metal or by mixing water and particles of at least one derivative of a useable metal.

According to the invention the preferred mixture (ME) is mixture (ME2).

Preferably according to the invention, the metal ore is chosen among a lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, lead ore. More preferably, the metal ore is not an aluminium ore. More preferably according to the invention, the metal ore is chosen among a uranium, molybdenum, manganese, iron, cobalt, nickel, copper, silver, gold ore. Much more preferably, it is a copper ore. It can also be a derivative of several useable metals comprising copper, zinc and cobalt.

According to the invention, the metal ore comprises at least one useable metal or at least one derivative of a useable metal obtained by separating all or part of the residue from the metal ore. Preferably according to the invention, the metal ore comprises a metal oxide, a metal sulphide or a metal carbonate.

Also preferably according to the invention, the metal ore residue comes from at least one metal ore chosen among a lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, lead ore. More preferentially, it comes from a metal ore chosen among a uranium, molybdenum, manganese, iron, cobalt, nickel, copper, silver, gold ore. Much more preferably, it comes from a copper ore.

Also preferably according to the invention, the metal ore residue comes from at least one metal ore comprising a metal oxide, a metal sulphide or a metal carbonate.

According to the invention, the metal ore residue may comprise a certain residual amount of metal. Particularly, the metal ore residue may comprise a residual amount of metal of less than 2,000 g per tonne (dry/dry) relative to the amount of metal ore residue. This amount of metal in the metal ore residue can typically range from 10 to 2,000 g per tonne (dry/dry) or from 10 to 1,000 g per tonne (dry/dry), relative to the amount of metal ore residue.

According to the invention, the useable metal is chosen among lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, lead, preferably among uranium, molybdenum, manganese, iron, cobalt, nickel, copper, silver, gold. Much more preferably, it is copper.

Likewise, according to the invention, the derivative of the useable metal comprises at least one metal chosen among lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, lead. Preferably, it comprises at least one metal chosen among uranium, molybdenum, manganese, iron, cobalt, nickel, copper, silver, gold. Much more preferably, it comprises copper.

The method according to the invention essentially uses recycling water.

Preferably, the recycling water used according to the invention comprises polymer (P). Also preferably, the recycling water used according to the invention comprises a fraction of the polymer (P) introduced into the mixture (ME). More preferably, this polymer fraction (P) ranges from 5 to 30%, preferably from 15 to 25%, particularly 20%, by weight (dry/dry) of the amount of polymer (P) introduced into the mixture (ME).

Preferably according to the invention, the recycling water has a turbidity of less than 1,000 NTUs, preferably less than 800 NTUs, more preferentially less than 600 NTUs or less than 400 NTUs, less than 300 NTUs or less than 200 NTUs.

Generally, the turbidity of the recycling water is greater than 0 NTUs or greater than 10 NTUs or greater than 20 NTUs. According to the invention, the turbidity of the recycling water will therefore range from 0 NTUs to 1,000 NTUs, to 800 NTUs, to 600 NTUs, to 400 NTUs, to 300 NTUs, to 200 NTUs. According to the invention, the turbidity of the recycling water can therefore also range from 10 NTUs to 1,000 NTUs, to 800 NTUs, to 600 NTUs, to 400 NTUs, to 300 NTUs, to 200 NTUs or even from 20 NTUs to

### 1,000 NTUs, to 800 NTUs, to 600 NTUs, to 400 NTUs, to 300 NTUs, to 200 NTUs.

Particularly advantageously, the use of the polymer (P) according to the invention makes it possible to improve the turbidity of the recycling water in comparison with water that does not comprise this polymer (P). Preferably according to the invention, the recycling water has a turbidity that is reduced by at least 30 to 50% or reduced by at least 30 to 60%, relative to the turbidity of a suspension that does not comprise any polymer. More preferably according to the invention, the recycling water has a turbidity that is reduced by at least 30 to 75% or reduced by 30 to 80% or by 30 to 90%, relative to the turbidity of a suspension that does not comprise any polymer.

Preferably, the recycling water according to the invention is separated water, in particular supernatant water separated during a mining process step.

According to the invention, the recycling water, preferably the supernatant water, can come in particular from a thickener, particularly a thickener used to concentrate a suspension of metal ore, a suspension of metal ore residue or a suspension of a useable metal or of a derivative of a useable metal.

According to the invention, the recycling water, preferably the supernatant water, can also come from a storage pond, particularly a pond used for storing an aqueous metal ore residue.

Preferably for the method according to the invention, the recycling water results from the pre-separation in at least one step of concentration of the aqueous suspension (S). More preferably for the method according to the invention, the recycling water results from the pre-separation in at least one concentration step chosen among:
gravimetric concentration, preferably gravimetric concentration in at least one pond in which the aqueous suspension (S) is stored or gravimetric concentration using at least one device chosen among a conventional thickener, a high-density thickener, a high-yield thickener;
densimetric concentration, preferably densimetric concentration using at least one device chosen among a conventional thickener, a high-density thickener, a high-yield thickener;
concentration by filtration, preferably concentration by filtration using at least one device chosen among a filter, a filter press, a rotary filter.

Particularly preferably for the method according to the invention, the recycling water results from the pre-separation in at least one concentration step chosen among:
gravimetric concentration, preferably gravimetric concentration in at least one pond in which the aqueous suspension (S) is stored or gravimetric concentration using at least one device chosen among a conventional thickener, a high-density thickener, a high-yield thickener;
densimetric concentration, preferably densimetric concentration using at least one device chosen among a conventional thickener, high-density thickener, high-yield thickener.

Also preferably for the method according to the invention, the recycling water comes from at least one thickener in which the aqueous suspension (S) is concentrated or comes from at least one pond in which the aqueous suspension (S) is stored.

Also preferably for the method according to the invention, the recycling water is a supernatant water resulting from the pre-separation producing a supernatant phase and a settling bed, more preferably in at least one step of concentration of the aqueous suspension (S).

According to the invention, the dry solids content of the suspension (S) may vary quite widely during the concentration steps carried out. Also preferably, the concentration of the suspension (S) is increased by 10 to 50% by weight or by 20 to 50% by weight or by 10 to 40% by weight or even by 20 to 40% by weight.

More preferably, the concentration of the suspension (S) is increased by 10 to 60% by weight or by 20 to 60% by weight.

Also more preferably, the concentration of the suspension (S) is increased by 10 to 70% by weight or by 20 to 70% by weight.

According to the invention, the decantation used can be counter-current decantation (CCD), particularly counter-current decantation of an aqueous suspension of useable metal or of a derivative of useable metal.

Preferably according to the invention, the recycling water is a supernatant water resulting from the pre-separation producing a supernatant phase and a settling bed. More preferably according to the invention, the recycling water is a supernatant water resulting from the pre-separation producing a supernatant phase and a settling bed that has:
a Brookfield viscosity, measured at 100 rpm and at 25° C., of less than 1,800 mPa·s; or
a flow threshold measured at a temperature of 25° C. using a rheometer with imposed shearing, equipped with a bladed spindle, for a particular torsional loading, of less than 80 Pa; or
a Brookfield viscosity, measured at 100 rpm and at 25° C., of less than 1,800 mPa·s and a flow threshold, measured at a temperature of 25° C. using a rheometer with imposed shearing, equipped with a bladed spindle, for a particular torsional loading, of less than 80 Pa.

According to the invention, the flow threshold, which characterises the flow resistance, is measured on a sample of an aqueous mineral suspension. The flow threshold is the shearing that must be applied to a suspension to cause it to flow. If the shearing is insufficient, the suspension deforms elastically whereas if the shearing is sufficient, the suspension can flow like a liquid.

According to the invention, the flow threshold expressed in Pascals (Pa) is measured at a temperature of 25° C. using a Brookfield DV3T rheometer with imposed shearing, equipped with a suitable spindle with blades. Without destroying the underlying structure, the bladed spindle is immersed into the material up to the first immersion mark. After a five-minute wait time, the measure is taken without pre-shearing at a speed of 0.5 rpm. This relatively low speed is preferred so as to minimise the inertia effect of the bladed spindle. The variation in torsional loading measured by the instrument in order to maintain a spin speed of 0.5 rpm is tracked over time. The value of the flow limit or flow threshold of the aqueous residue is indicated by the instrument when this variation is zero.

Also more preferably according to the invention, the recycling water is a supernatant water resulting from the pre-separation producing a supernatant phase and a settling bed that has:
a flow threshold of less than 70 Pa or less than 60 Pa, preferably less than 50 Pa or less than 40 Pa, more preferentially less than 30 Pa or less than 20 Pa; or
a flow threshold greater than 10 Pa, preferably greater than 12 Pa, more preferentially greater than 15 Pa; or
a flow threshold greater than 10 Pa, preferably greater than 12 Pa, more preferentially greater than 15 Pa and less than 70 Pa or less than 60 Pa, preferably less than 50 Pa or less than 40 Pa, more preferentially less than 30 Pa or less than 20 Pa; or
a viscosity of less than 1,500 mPa·s, preferably less than 1,200 mPa·s, more preferentially less than 1,000 mPa·s or less than 900 mPa·s, much more preferentially less than 800 mPa·s or less than 700 mPa·s, or even less than 500 mPa·s.

Also more preferably according to the invention, the recycling water is a supernatant water resulting from the pre-separation producing a supernatant phase and a settling bed.

The method according to the invention may use one or more polymers (P). Preferably, the suspension (S) prepared thus comprises one, two or three different polymers (P). The method according to the invention may also comprise the further addition of at least one compound chosen among a lignosulphonate derivative, a silicate, an unmodified polysaccharide, and a modified polysaccharide.

The method according to the invention makes it possible to prepare an aqueous suspension (S) that comprises in particular recycling water, a polymer (P) and a mixture (ME). The aqueous suspension (S) therefore comprises particles of at least one mining derivative. Preferably according to the invention, the aqueous suspension (S) has a dry solids content greater than 10% by weight or greater than 15% by weight or greater than 20% by weight. Also preferably according to the invention, the aqueous suspension (S) has a dry solids content of less than 50% by weight or less than 40% by weight or less than 35% by weight.

Also preferably according to the invention, the aqueous suspension (S) has a dry solids content ranging from 10 to 50% by weight or from 15 to 50% by weight or from 15 to 40% by weight or from 15 to 35% by weight or from 20 to 50% by weight or from 20 to 40% by weight or from 20 to 35% by weight.

When used according to the invention, the polymer (P) can be used in different amounts. Preferably according to the invention, the aqueous suspension (S) comprising the mixture (ME) and the recycling water comprises from 0.01 to 2% by weight of polymer (P) (dry/dry relative to the aqueous suspension (S)), more preferentially from 0.01 to 1.8% or from 0.01 to 1.5%, much more preferentially from 0.01 to 1.2% or from 0.01 to 1%, or from 0.02 to 0.8% or from 0.03 to 0.5%, even more preferentially from 0.04 to 0.25% or from 0.04 to 0.15%.

The method according to the invention uses at least one particular polymer (P). It is prepared by a polymerisation reaction in the presence of at least one radical-generating compound chosen among hydrogen peroxide, benzoyl peroxide, acetyl peroxide, lauryl peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof. Preferably, this polymerisation reaction does not use benzoyl peroxide.

In addition to this radical-generating compound, the polymerisation reaction can also be carried out in the presence of at least one compound comprising phosphorus in the oxidation I state, preferably a compound chosen among hypophosphorous acid (H₃PO₂) and a derivative of hypophosphorous acid (H₃PO₂), preferably a compound comprising at least one hypophosphite ion (H₂PO₂), more preferentially a compound chosen among sodium hypophosphite (H₂PO₂Na), potassium hypophosphite (H₂PO₂K), calcium hypophosphite ([H₂PO₂]₂Ca) and mixtures thereof.

Likewise, the polymerisation reaction can be carried out in the presence of at least one compound comprising phosphorus in the oxidation III state, preferably a compound chosen among phosphorous acid and a derivative of phosphorous acid, more preferentially a compound comprising at least one phosphite ion, in particular a compound chosen among sodium phosphite, calcium phosphite, potassium phosphite, ammonium phosphite, and combinations thereof.

The polymerisation reaction can also be carried out in the presence of at least one compound comprising a bisulphite ion, preferably a compound chosen among ammonium bisulphite, an alkaline metal bisulphite, in particular sodium bisulphite, potassium bisulphite, calcium bisulphite, magnesium bisulphite, and combinations thereof.

The polymerisation reaction can also be carried out in the presence of from 0.05 to 5% by weight, relative to the total amount of monomers, of at least one compound chosen among a xanthate derivative, a mercaptan compound and a compound of formula (I):

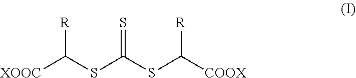

wherein:
   X independently represents H, Na or K and
   R independently represents a C₁-C₅-alkyl group, preferably a methyl group; particularly a compound of formula (I) which is disodic diisopropionate trithiocarbonate (DPTTC).

According to the invention, the polymerisation reaction is carried out at a temperature greater than 50° C. Preferably, the polymerisation reaction is carried out at a temperature ranging from 50 to 98° C. or from 50 to 95° C. or from 50 to 85° C. A higher temperature, in particular above 100° C., may be used by adjusting the pressure of the reaction medium to prevent evaporation.

Preferably, the polymerisation reaction is carried out in water. It can also be carried out in a solvent, alone or mixed with water, in particular an alcoholic solvent, particularly isopropyl alcohol. More preferably, it is carried out in water.

Advantageously, the polymer (P) used according to the invention has a molecular mass Mw, measured by GPC, ranging from 2,200 to 10,000 g/mol. Preferably, the polymer (P) used according to the invention has a molecular mass Mw ranging from 2,400 to 9,500 g/mol or from 2,400 to 8,000 g/mol, more preferentially from 2,400 to 6,500 g/mol. The polymer (P) used according to the invention is therefore not a flocculating agent.

According to the invention, the molecular mass Mw mass is determined by Gel Permeation Chromatography (GPC). This technique uses a Waters liquid chromatography apparatus equipped with a detector. This detector is a Waters refractive index detector. This liquid chromatography apparatus is equipped with a size exclusion column in order to separate the various molecular weights of the copolymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the copolymer solution is diluted to 0.9% by dry weight in the dissolution solvent of the GPC, which corresponds to the liquid elution phase of the GPC to which is added 0.04% of dimethyl formamide which acts as a flow rate marker or internal standard. Then it is filtered using a 0.2 μm filter. Then 100 μL are injected into the chromatograph instrument (eluent: an aqueous phase adjusted to pH 9.00 by 1N sodium hydroxide containing 0.05 M of NaHCO₃, 0.1 of M NaNO₃, 0.02 M of triethanolamine and 0.03% of NaN₃).

The liquid chromatography instrument has an isocratic pump (Waters 515) the flow rate of which is set to 0.8 mL/min. The chromatography instrument also comprises an oven which itself comprises the following system of columns in series: a Waters Ultrahydrogel Guard precolumn 6 cm long and 40 mm in inner diameter and a Waters Ultrahydrogel linear column 30 cm long and 7.8 mm in inner diameter. The detection system is comprised of a Waters 410 RI refractive index detector. The oven is heated to 60° C. and the refractometer is heated to 45° C.

The chromatography instrument is calibrated using powdered sodium polyacrylate standards of different molecular masses certified by the supplier: Polymer Standards Service or American Polymers Standards Corporation (molecular mass ranging from 900 to 2.25×10⁶ g/mol and polymolecularity index ranging from 1.4 to 1.8).

The polymer (P) used according to the invention can be completely or partially neutralised, in particular at the end of the polymerisation reaction. According to the invention, the neutralisation of the polymer is carried out by neutralising or salifying all or part of the carboxylic acid groups present in the polymer. Preferably, this neutralisation is carried out using a base, for example using a derivative of an alkaline metal or a derivative of an alkaline-earth metal. The preferred bases are chosen among ZnO, MgO, NaOH, KOH, NH₄OH, Ca(OH)₂, Mg(OH)₂, monoisopropylamine, triethanolamine, triisopropylamine, 2-amino-2-methyl-1-propanol (AMP), tri ethyl amine, diethylamine, monoethylamine. Particularly preferably, neutralisation is carried out using ZnO, MgO, NaOH, Ca(OH)₂, Mg(OH)₂, alone or in combination.

According to the invention, the polymerisation reaction uses at least one anionic monomer (M) comprising at least one polymerisable olefinic unsaturation and at least one carboxylic acid group or one of its salts. Preferably, the anionic monomer (M) comprising at least one polymerisable olefinic unsaturation comprises one or two carboxylic acid groups, particularly a single carboxylic acid group. More preferentially, it is chosen among acrylic acid, methacrylic acid, an acrylic acid salt, a methacrylic acid salt and mixtures thereof, much more preferentially acrylic acid.

Preferably, the polymerisation reaction uses 100% by weight of anionic monomer (M) or from 70% to 99.5% by weight of anionic monomer (M) and from 0.5% to 30% by weight of at least one other monomer.

Advantageously, the polymerisation reaction can thus also use at least one other monomer chosen among:
another anionic monomer, preferably a monomer chosen among acrylic acid, methacrylic acid, itaconic acid, maleic acid, maleic anhydride and mixtures thereof;
2-acrylamido-2-methylpropanesulphonic acid, a salt of 2-acrylamido-2-methylpropanesulphonic acid, 2-(methacryloyloxy)ethanesulphonic acid, a salt of 2-(methacryloyloxy)ethanesulphonic acid, sodium methallyl sulphonate, styrene sulphonate and combinations or mixtures thereof;
a non-ionic monomer comprising at least one polymerisable olefinic unsaturation, preferably at least one polymerisable ethylenic unsaturation and in particular a polymerisable vinyl group, more preferentially a non-ionic monomer chosen among styrene, vinyl caprolactam, the esters of an acid comprising at least one monocarboxylic acid group, in particular an ester of an acid chosen among acrylic acid, methacrylic acid and mixtures thereof, for example hydroxyethyl acrylate, hydroxypropyl acrylate, hydroxyethyl methacrylate, hydroxypropyl methacrylate, alkyl acrylate, in particular C₁-C₁₀-alkyl acrylate, preferentially C₁-C₄-alkyl acrylate, more preferentially methyl acrylate, ethyl acrylate, n-propyl acrylate, isopropyl acrylate, isobutyl acrylate, n-butyl acrylate, alkyl methacrylate, in particular C₁-C₁₀-alkyl methacrylate, preferentially C₁-C₄-alkyl methacrylate, more preferentially methyl methacrylate, ethyl methacrylate, n-propyl methacrylate, isopropyl methacrylate, isobutyl methacrylate, n-butyl methacrylate, aryl acrylate, preferably phenyl acrylate, benzyl acrylate, phenoxyethyl acrylate, aryl methacrylate, preferably phenyl methacrylate, benzyl methacrylate, phenoxyethyl methacrylate;
a monomer of formula (II):

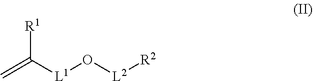

wherein:
   R¹ and R², identical or different, independently represent H or CH₃,
   L¹ independently represents a group chosen among C(O), CH₂, CH₂—CH₂ and O—CH₂—CH₂—CH₂—CH₂,
   L² independently represents a group chosen among (CH₂—CH₂O)ₓ, (CH₂CH(CH₃)O)_{y}, (CH(CH₃)CH₂O)_{z} and combinations thereof and
   x, y and z, identical or different, independently represent an integer or decimal comprised in a range from 0 to 150 and the sum of x+y+z is comprised in a range from 10 to 150.

Particularly preferably, the monomer of formula (II) is such that:
R¹ represents CH₃,
R² represents H,
L¹ represents a C(O) group,
L² independently represents a combination of groups chosen among (CH₂—CH₂O)ₓ, (CH₂CH(CH₃)O)_{y}, (CH(CH₃)CH₂O)_{z} and
x, y and z, identical or different, independently represent an integer or decimal comprised in a range from 0 to 150 and the sum of x+y+z is comprised in a range from 10 to 150.

Preferably, the polymer (P) used according to the invention is a non-sulphonated polymer.

When preparing the polymer (P) used according to the invention, a separation step can also be carried out. According to the invention, the separation can be carried out after the full or partial neutralisation of the polymer (P). It can also be carried out prior to neutralising the polymer (P).

The aqueous solution of the fully or partially neutralised polymer (P) can be processed using the static or dynamic split methods known as such. Then one or more polar solvents is used, in particular from the group comprised of methanol, ethanol, n-propanol, isopropanol, butanols, acetone, and tetrahydrofuran, thus resulting in a two-phase separation. During the separation, the least dense phase comprises the largest fraction of the polar solvent and the fraction of polymers with low molecular weight, and the densest aqueous phase comprises the fraction of polymers with the highest molecular weight. The temperature at which the polymer fraction selection is processed can influence the partition coefficient. It is typically comprised within a range of from 10 to 80° C., preferably from 20 to 60° C. During the separation, it is important to control the ratio of the amounts of dilution water and polar solvents.

When using a dynamic separation method, for example centrifugation, the ratios of the extracted fractions typically depend on the centrifugation conditions. The selection of the fraction of the polymers can also be improved by re-processing the densest aqueous phase using a new amount of polar solvent, which can be different. It can also be a mixture of polar solvents. Lastly, the liquid phase obtained after processing can be distilled to eliminate the solvent(s) used in processing.

The method of preparation according to the invention makes it possible to prepare a suspension (S) comprising at least one polymer (P) that has particularly advantageous properties, in particular rheological properties that are particularly advantageous.

Thus, the invention also provides an aqueous mineral suspension (S) of mineral particles chosen among particles of at least one metal ore, particles of at least one metal ore residue, particles of at least one useable metal or at least one derivative of a useable metal, and combinations thereof, comprising the addition in a mixture (ME) chosen among:
a mixture (ME1) comprising water and particles of at least one metal ore,
a mixture (ME2) comprising water and particles of at least one metal ore residue,
a mixture (ME3) comprising water and particles of at least one useable metal or of at least one derivative of a useable metal,
a mixture (ME4) comprising at least two mixtures chosen among (ME1), (ME2) and (ME3);
   of recycling water
from at least one aqueous metal ore residue or from at least one aqueous suspension of metal ore or from at least one aqueous suspension of a useable metal or of a derivative of a useable metal and
comprising an aqueous metal ore residue and at least one polymer (P) with a molecular mass Mw, measured by GPC, ranging from 2,000 to 20,000 g/mol and prepared by radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound chosen among hydrogen peroxide, benzoyl peroxide, acetyl peroxide, lauryl peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof.

Preferably according to the invention, for the aqueous mineral suspension (S), the recycling water is a supernatant water resulting from the pre-separation producing a supernatant phase and a settling bed, preferably in at least one concentration step of the aqueous suspension (S).

More preferably according to the invention, for the aqueous mineral suspension (S), the recycling water is a supernatant water resulting from the pre-separation producing a supernatant phase and a settling bed that has:
a Brookfield viscosity, measured at 100 rpm and at 25° C., of less than 1,800 mPa·s; or
a flow threshold measured at a temperature of 25° C. using a rheometer with imposed shearing, equipped with a bladed spindle, for a particular torsional loading, of less than 80 Pa; or
a Brookfield viscosity, measured at 100 rpm and at 25° C., of less than 1,800 mPa·s and a flow threshold, measured at a temperature of 25° C. using a rheometer with imposed shearing, equipped with a bladed spindle, for a particular torsional loading, of less than 80 Pa.

More preferably according to the invention, for the aqueous mineral suspension (S), the recycling water is a supernatant water resulting from the pre-separation producing a supernatant phase and a settling bed that has:
a flow threshold of less than 70 Pa or less than 60 Pa, preferably less than 50 Pa or less than 40 Pa, more preferentially less than 30 Pa or less than 20 Pa; or
a flow threshold greater than 10 Pa, preferably greater than 12 Pa, more preferentially greater than 15 Pa; or
a flow threshold greater than 10 Pa, preferably greater than 12 Pa, more preferentially greater than 15 Pa and less than 70 Pa or less than 60 Pa, preferably less than 50 Pa or less than 40 Pa, more preferentially less than 30 Pa or less than 20 Pa; or
a viscosity of less than 1,500 mPa·s, preferably less than 1,200 mPa·s, more preferentially less than 1,000 mPa·s or less than 900 mPa·s, much more preferentially less than 800 mPa·s or less than 700 mPa·s, or even less than 500 mPa·s.

More preferably according to the invention, for the aqueous mineral suspension (S), the recycling water is a supernatant water resulting from the pre-separation producing a supernatant phase and a settling bed.

Furthermore, the invention also provides a method for controlling, improving or reducing the turbidity of the supernatant water resulting from the separation producing a supernatant phase and a settling bed, of an aqueous suspension (S) of mineral particles chosen among particles of at least one metal ore, particles of at least one metal ore residue, particles of at least one useable metal or of at least one derivative of a useable metal, and combinations thereof, including addition in a mixture (ME) chosen among:
a mixture (ME1) comprising water and particles of at least one metal ore,
a mixture (ME2) comprising water and particles of at least one metal ore residue,
a mixture (ME3) comprising water and particles of at least one useable metal or of at least one derivative of a useable metal,
a mixture (ME4) comprising at least two mixtures chosen among (ME1), (ME2) and (ME3);
   comprising at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound chosen among hydrogen peroxide, benzoyl peroxide, acetyl peroxide, lauryl peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof.

Preferably, this method uses a separation step producing a supernatant phase and a settling bed from the aqueous suspension (S) that is obtained in at least one concentration step of the aqueous suspension (S).

Also preferably, the supernatant phase is thus recyclable water. This water is recyclable in at least one aqueous metal ore residue or in at least one aqueous suspension of metal ore or in at least one aqueous suspension of a useable metal or of a derivative of a useable metal.

The particular, advantageous or preferred characteristics of the method for preparing the suspension (S) according to the invention define suspensions (S) according to the invention which are also particular, advantageous or preferred. Likewise the particular, advantageous or preferred characteristics of the method for preparing the suspension (S) according to the invention define methods for controlling, improving or reducing the turbidity of the supernatant water resulting from the separation producing a supernatant phase and a settling bed, of an aqueous suspension (S) according to the invention which are also particular, advantageous or preferred.

The following examples illustrate the various aspects of the invention.

The polymers used in the method according to the invention are prepared.

Polymer (P1) is prepared by placing 156 g of water and 0.013 g of iron sulphate heptahydrate into a one-litre glass reactor with mechanical stirring and oil bath heating.

271 g of acrylic acid at 100% by weight is weighed into a 500 mL beaker fitted with a dosing pump.

3.3 g of persulphate diluted in 15 g of water is weighed into a 20 mL test tube fitted with a dosing pump.

115 g of sodium bisulphite at 40% by weight is weighed into a 200 mL test tube fitted with a dosing pump.

The reactor is heated to 80° C.

30% of the persulphate solution is injected rapidly and then the remainder of this solution, the acrylic acid and the bisulphite solution are injected in parallel in:
3 h for the acrylic acid,
3.5 h for the persulphate and the bisulphite.

The reaction medium is kept at 80° C.

The medium is then heat-treated for 30 minutes with a solution of 0.3 g of persulphate in 4 g of water and then 4.5 g of hydrogen peroxide at 130 V.

Lastly, the pumps are rinsed with water.

The medium is heated again for 60 min at 80° C.

The solution is then neutralised using 50% by weight of sodium hydroxide in water until it reaches pH 8 and then diluted to a solids content of 42% by weight. Polymer (P1) is obtained, with a molecular mass Mw, measured by GPC, of 2,500 g/mol.

Polymer (P2) is prepared by placing 212 g water and 0.08 g of iron sulphate heptahydrate into a one-litre glass reactor with mechanical stirring and oil bath heating.

303 g of acrylic acid at 100% by weight and 15 g of water are weighed into a 500 mL beaker fitted with a dosing pump.

25.6 g of sodium hypophosphite monohydrate diluted with 30 g of water is weighed into a 100 mL test tube fitted with a dosing pump.

21 g of hydrogen peroxide at 130 V and 35 g of water are weighed into a 100 mL test tube fitted with a dosing pump.

The reactor is heated to 95° C. and the monomer, the hypophosphite solution and the hydrogen peroxide solution are added in parallel in 120 min while keeping the temperature of the reaction medium at 95° C.

Lastly, the pumps are rinsed with water.

The medium is heated again for 60 min at 95° C.

The solution is then neutralised using 50% by weight of sodium hydroxide in water until it reaches pH 8 and then diluted to a solids content of 42% by weight. Polymer (P2) is obtained, with a molecular mass Mw, measured by GPC, of 4,500 g/mol.

The raw material used for this series of tests is an aqueous metal ore residue from a Chilean copper mine located in the north of the country. This is waste resulting from the separation of the ore containing the useable metal from the rock extracted from the mine.

This aqueous copper ore residue is in the form of a water-based suspension.

Various measurements were taken beforehand on the aqueous residue in the absence of the polymer according to the invention:
particle size distribution using a Mastersizer 2000 laser granulometer (Malvern): D(80) of 243.1 μm and,
solids content using a Mettler-Toledo dry balance: 63.5%.

A test is then performed to assess the efficacy of the polymer on the settling of a suspension of aqueous copper ore residue when concentrating this residue by settling. This settling test is carried out using a suspension with a solids content of 30% by weight. This suspension with a solids content of 30% by weight is prepared by diluting the aqueous suspension of residue with a solids content of 63.5%.

A sample of 30% suspension of aqueous copper ore residue is transferred into a 500 mL beaker and then mechanically stirred with a Raynerie mixer. Stirring is carried out at 500 rpm.

Then, a polymer (P1) according to the invention is added at a dose of 0.05% by weight dry/dry relative to the dry residue and the mixture is left under stirring for 15 min.

The dispersed suspension is then incorporated into a 2-litre graduated test tube with a mechanical stirrer and stirred at 0.8 rpm.

A fixed dose of an acrylamide flocculating agent is incorporated at a dose equivalent to 12 g/T dry/dry of residue.

A test is carried out on the polymer (P1) and a comparative test is carried out without any polymer in the suspension.

After preparing a sample of the suspension, settling takes place gradually over time due to the phenomenon of flocculation of the solid particles comprised in the aqueous copper ore residue. These particles agglomerate to form heavier particle clusters. These clusters then settle faster. The aqueous supernatant phase is on the surface and the settled phase is at the bottom of the test tube. The supernatant water is then sampled and placed in a 50 mL beaker before preparing a vial to measure the turbidity.

The turbidity of the supernatant water from the suspensions is measured (in NTUs or Nephelometric Turbidity Units) using a portable turbidimeter (Hatch 2100Q). These measures correspond to the turbidity of the supernatant water from the suspension of the aqueous residue at the top of a thickener, during the phase in which this residue is concentrated by settling. The settling speed is also measured using the scale on the test tube and a stopwatch. This measure is performed by observing the separation of the supernatant water phase and settling phase. It is measured in cm/minute and then converted to metres/hour.

The results are shown in Table 1.

TABLE 1

| | Settling speed | Turbidity | % Solids |
|---|---|---|---|
| Suspension | in m/h | in NTUs | content |
| without polymer | 7.6 | 109 | 64.6 |
| with polymer (P1) | 7.1 | 47 | 63.7 |

Moreover, a test is carried out using semi-industrial equipment. The settler is cylindrical with a clear wall. It has a capacity of 30 L and is stirred by means of a low-power motor supplying a stirring speed of 1 rpm.

The suspension of aqueous copper ore residue used has a solids content of 69% in dry/dry weight.

A fixed dose of an acrylamide flocculating agent is incorporated at a dose equivalent to 12 g/T dry/dry of residue.

The turbidity of the supernatant water from the suspensions is measured (in NTUs or Nephelometric Turbidity Units) using a portable turbidimeter (Hatch 2100Q). These measures correspond to the turbidity of the supernatant water (overflow) of the suspension of the aqueous residue at the top of a thickener, during the step in which this residue is concentrated by settling. It takes approximately three hours to sufficiently concentrate the settling bed and obtain a separation of the sediment and of the relatively clear supernatant water. The results are shown in Table 2.

TABLE 2

| Suspension | Turbidity in NTUs | % Solids content |
|---|---|---|
| without polymer | 868 | 69 |
| with polymer (P1) | 253 | 69 |

When testing the concentration of aqueous copper ore residue by settling, the polymer (P1) according to the invention systematically improves the turbidity of supernatant water, be this surface water or overflow water. This supernatant water can therefore be easily recycled, in particular during a step in a mining method. Indeed, as this water thus contains fewer fine particles, it is clearer. Water with a lower load of fine particles can therefore be recycled faster as it requiring fewer clarification steps.

1. A method for preparing an aqueous mineral suspension (S) of mineral particles, the method comprising:
adding recycling water comprising a polymer (P) in a mixture,
wherein the mineral particles are selected from the group consisting of particles of at least one metal ore, particles of at least one metal ore residue, particles of at least one useable metal or of at least one derivative of a useable metal, and combinations thereof,
the mixture is a mixture (ME) selected from the group consisting of:
a mixture (ME1) comprising water and particles of at least one metal ore,
a mixture (ME2) comprising water and particles of at least one metal ore residue,
a mixture (ME3) comprising water and particles of at least one useable metal or of at least one derivative of a useable metal, and
a mixture (ME4) comprising at least two mixtures selected from the group consisting of the mixtures (ME1), (ME2) and (ME3);
the recycling water is a recycling water from at least one aqueous metal ore residue, at least one aqueous suspension of metal ore, or at least one aqueous suspension of a useable metal or a derivative of a useable metal and
the polymer (P) is a polymer having a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound selected from the group consisting of hydrogen peroxide, benzoyl peroxide, acetyl peroxide, lauryl peroxide, tert-butyl hydroperoxide, cumene hydroperoxide, ammonium persulphate, an alkaline metal persulphate, an azo compound, and their respective combinations or associations with an ion selected from the group consisting of Fe^{II}, Fe^{III}, Cu^{I}, Cu^{II} and mixtures thereof.

2. The method according to claim 1, wherein
the metal ore is selected from the group consisting of a lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, and lead ore;
the metal ore comprises a metal oxide, a metal sulphide or a metal carbonate;
the metal ore residue results from at least one metal ore selected from the group consisting of a lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, and lead ore;
the metal ore residue results from at least one metal ore comprising a metal oxide, a metal sulphide or a metal carbonate; or
the metal ore residue comprises a residual amount of metal of less than 2,000 g per tonne (dry/dry) relative to an amount of metal ore residue.

3. The method according to claim 1, in which wherein the recycling water has:
a turbidity of less than 1,000 NTUs;
a turbidity greater than 0 NTUs;
a turbidity ranging from 0 NTUs to 1,000 NTUs; or
a turbidity that is reduced by at least 30 to 50%, relative to a turbidity of a suspension that does not comprise any polymer.

4. The method according to claim 1, in which wherein the recycling water results from a pre-separation in at least one concentration process of the aqueous suspension (S).

5. The method according to claim 1, wherein the recycling water comes from at least one thickener in which the aqueous suspension (S) is concentrated or comes from at least one pond in which the aqueous suspension (S) is stored.

6. The method according to claim 1, wherein the recycling water is a supernatant water resulting from a pre-separation producing a supernatant phase and a settling bed.

7. The method according to claim 1, wherein the recycling water is a supernatant water resulting from a pre-separation producing a supernatant phase and a settling bed that has:
a Brookfield viscosity, measured at 100 rpm and at 25° C., of less than 1,800 mPa·s;
a flow threshold measured at a temperature of 25° C. using a rheometer with imposed shearing, equipped with a bladed spindle, for a particular torsional loading, of less than 80 Pa; or
a Brookfield viscosity, measured at 100 rpm and at 25° C., of less than 1,800 mPa·s and a flow threshold, measured at a temperature of 25° C. using a rheometer with imposed shearing, equipped with a bladed spindle, for a particular torsional loading, of less than 80 Pa.

8. The method according to claim 1, wherein the recycling water is a supernatant water resulting from a pre-separation producing a supernatant phase and a settling bed that has:
a flow threshold of less than 70 Pa;
a flow threshold greater than 10 Pa;
a flow threshold greater than 10 Pa; or
a viscosity of less than 1,500 mPa·s.

9. The method according claim 1, wherein the recycling water is a supernatant water resulting from a pre-separation producing a supernatant phase and a settling bed in at least one concentration process of the aqueous suspension (S).

10. The method according to claim 1, further comprising: adding one, two or three different polymer(s) (P) or at least one additional compound selected from the group consisting of a lignosulphonate derivative, a silicate, an unmodified polysaccharide and a modified polysaccharide in the mixture.

11. The method according to claim 1, wherein the aqueous suspension (S) has a dry solids content:
greater than 10% by weight;
less than 50% by weight;
ranging from 10 to 50% by weight.

12. The method according to claim 1, wherein the aqueous suspension (S) comprises the mixture (ME) and the recycling water comprises from 0.01 to 2% by weight of polymer (P) (dry/dry relative to the aqueous suspension (S)).

13. The method according to claim 1, wherein:
the polymerisation reaction is also carried out in the presence of at least one compound comprising phosphorus in the oxidation 1 state;
the polymerisation reaction is carried out in the presence of at least one compound comprising phosphorus in the oxidation III state;
the polymerisation reaction is also carried out in the presence of at least one compound comprising a bisulphite ion;
the polymerisation reaction is also carried out in the presence of from 0.05 to 5% by weight, relative to a total amount of monomers, of at least one compound selected from the group consisting of a xanthate derivative, a mercaptan compound and a compound of formula (I): 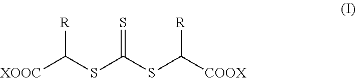
wherein:
X independently represents H, Na or K and
R independently represents a C₁-C₅-alkyl group;
the polymerisation reaction is carried out at a temperature ranging from 50 to 98° C.;
the polymerisation reaction is carried out in water, in a solvent, alone or in a mixture with water;
the polymer (P) has a molecular mass Mw, measured by GPC, ranging from 2,200 to 10,000 g/mol;
the polymer (P) is completely or partially neutralised; or
the polymerisation reaction uses:
100% by weight of the at least one anionic monomer (M) or
from 70% to 99.5% by weight of the at least one anionic monomer (M) and from 0.5% to 30% by weight of at least one other monomer.

14. The method according to claim 1, wherein the at least one anionic monomer (M) comprises one or two carboxylic acid groups.

15. The method according to claim 1, wherein the polymerisation reaction also uses at least another monomer selected from the group consisting of:
another anionic monomer;
2-acrylamido-2-methylpropanesulphonic acid, a salt of 2-acrylamido-2-methylpropanesulphonic acid, 2-(methacryloyloxy)ethanesulphonic acid, a salt of 2-(methacryloyloxy)ethanesulphonic acid, sodium methallyl sulphonate, styrene sulphonate and combinations or mixtures thereof;
a non-ionic monomer comprising at least one polymerisable olefinic unsaturation;
a monomer of formula (II): 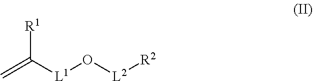
wherein:
R¹ and R², identical or different, independently represent H or CH₃,
L¹ independently represents a group selected from the group consisting of C(O), CH₂, CH₂—CH₂ and O—CH₂—CH₂—CH₂—CH₂,
L² independently represents a group selected from the group consisting of (CH₂—CH₂O)ₓ, (CH₂CH(CH₃)O)_{y}, (CH(CH₃)CH₂O)_{z} and combinations thereof and
x, y and z, identical or different, independently represent an integer or decimal comprised in a range from 0 to 150 and a sum of x+y+z is comprised in a range from 10 to 150.

16. An aqueous mineral suspension (S) of mineral particles selected from the group consisting of particles of at least one metal ore, particles of at least one metal ore residue, particles of at least one useable metal or at least one derivative of a useable metal, and combinations thereof, prepared by an addition in a mixture (ME) selected from the group consisting of:
a mixture (ME1) comprising water and particles of at least one metal ore, a mixture (ME2) comprising water and particles of at least one metal ore residue,
a mixture (ME3) comprising water and particles of at least one useable metal or of at least one derivative of a useable metal,
a mixture (ME4) comprising at least two mixtures selected from the group consisting of mixtures (ME1), (ME2) and (ME3);
of recycling water
from at least one aqueous metal ore residue, at least one aqueous suspension of metal ore, or at least one aqueous suspension of a useable metal or a derivative of a useable metal and
comprising a polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound selected from the group consisting of hydrogen peroxide, benzoyl peroxide, acetyl peroxide, lauryl peroxide, tert-butyl hydroperoxide, cumene hydroperoxide, ammonium persulphate, an alkaline metal persulphate, an azo compound, and their respective combinations or associations with an ion selected from the group consisting of Fe^{II}, Fe^{III}, Cu^{I}, Cu^{II} and mixtures thereof.

17. The aqueous mineral suspension (S) according to claim 16, wherein the recycling water is a supernatant water resulting from a pre-separation producing a supernatant phase and a settling bed.

18. The method according to claim 1, wherein:
the recycling water is a supernatant water resulting from a pre-separation producing a supernatant phase and a settling bed that has:
a Brookfield viscosity, measured at 100 rpm and at 25° C., of less than 1,800 mPa·s;
a flow threshold measured at a temperature of 25° C. using a rheometer with imposed shearing, equipped with a bladed spindle, for a particular torsional loading, of less than 80 Pa; or
a Brookfield viscosity, measured at 100 rpm and at 25° C., of less than 1,800 mPa·s and a flow threshold, measured at a temperature of 25° C. using a rheometer with imposed shearing, equipped with a bladed spindle, for a particular torsional loading, of less than 80 Pa;
wherein:
the recycling water is a supernatant water resulting from the pre-separation producing a supernatant phase and a settling bed that has:
a flow threshold of less than 70 Pa;
a flow threshold greater than 10 Pa;
a flow threshold greater than 10 Pa; or
a viscosity of less than 1,500 mPa·s;
or
wherein:
the recycling water is a supernatant water resulting from the pre-separation producing a supernatant phase and a settling bed.

19. A method for controlling, improving or reducing a turbidity of a supernatant water resulting from a separation producing a supernatant phase and a settling bed, of an aqueous suspension (S) of mineral particles selected from the group consisting of particles of at least one metal ore, particles of at least one metal ore residue, particles of at least one useable metal or at least one derivative of a useable metal, and combinations thereof, the method comprising:
adding in a mixture (ME) selected from the group consisting of:
a mixture (ME1) comprising water and particles of at least one metal ore,
a mixture (ME2) comprising water and particles of at least one metal ore residue,
a mixture (ME3) comprising water and particles of at least one useable metal or of at least one derivative of a useable metal,
a mixture (ME4) comprising at least two mixtures selected from the group consisting of the mixtures (ME1), (ME2) and (ME3);
of at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound selected from the group consisting of hydrogen peroxide, benzoyl peroxide, acetyl peroxide, lauryl peroxide, tert-butyl hydroperoxide, cumene hydroperoxide, ammonium persulphate, an alkaline metal persulphate, an azo compound, and their respective combinations or associations with an ion selected from the group consisting of Fe^{II}, Fe^{III}, Cu^{I}, Cu^{II} and mixtures thereof.

20. The method according to claim 18, wherein the separation producing a supernatant phase and a settling bed from the aqueous suspension (S) is obtained in at least one concentration process of the aqueous suspension (S).

21. The method according to claim 18, wherein the supernatant phase is recyclable water.
